(19) United States
(12) Patent Application Publication
(10) Pub. No.: US 2024/0050788 A1
(43) Pub. Date: Feb. 15, 2024

(54) AUTOMATIC FIRE-EXTINGUISHING SYSTEM AND METHOD FOR CABLE TUNNEL

(71) Applicants: State Grid Shandong Electric Power Research Institute, Jinan, Shandong (CN); State Grid Corporation of China, Beijing (CN)

(72) Inventors: Hao Zhang, Jinan, Shandong (CN); Jinxia Yao, Jinan, Shandong (CN); Yubing Duan, Jinan, Shandong (CN); Pengfei Li, Jinan, Shandong (CN); Guoqing Ma, Jinan, Shandong (CN); Xiaoli Hu, Jinan, Shandong (CN); Chao Gu, Jinan, Shandong (CN); Ran Jia, Jinan, Shandong (CN); Jingguo Ren, Jinan, Shandong (CN); Jie Li, Jinan, Shandong (CN); Wei Shi, Jinan, Shandong (CN); Jingwen Sun, Jinan, Shandong (CN); Hui Liu, Jinan, Shandong (CN); Yang Zhang, Jinan, Shandong (CN); Chao Zhou, Jinan, Shandong (CN)

(21) Appl. No.: 17/765,455

(22) PCT Filed: Dec. 27, 2021
(86) PCT No.: PCT/CN2021/141487

§ 371 Date: Mar. 31, 2022

(30) Foreign Application Priority Data
Mar. 25, 2021 (CN) 202110322894.6

(51) Int. Cl. A62C 3/16; A62C 37/36; A62C 27/00

(52) U.S. Cl. CPC A62C 3/16; A62C 37/04; A62C 27/00

(57) ABSTRACT

An automatic fire-extinguishing system and method for a cable tunnel. The system includes an inspection robot, a positioning robot, and guide rails fixed on an inner top of the tunnel, where the inspection robot and the positioning robot are connected to the guide rails respectively, and the positioning robot is arranged in a groove of the inspection robot and able to be moved by the inspection robot along the guide rails; and the positioning robot is able to independently enter and exit an inner space of the inspection robot along the guide rails, and the positioning robot is configured to control a built-in fire-extinguishing mechanism to extinguish fire at a position with a preset distance from a fire source. Both fire-fighting medium docking and fire extinguishing are realized; a quick access to a battery is realized and fire-extinguishing inspection efficiency of a cable tunnel is improved.

### TECHNICAL FIELD

The present disclosure relates to a field of fire prevention of cable tunnels, and in particular to an automatic fire-extinguishing system and method for a cable tunnel.

### BACKGROUND

This part is merely intended to provide background arts related to the present disclosure, and does not necessarily constitute the prior art.

A cable tunnel refers to a corridor or a tunnel-like structure configured to accommodate a large number of cables laid on a cable bracket. In addition to well protection of cables in tunnels, cable tunnels can facilitate an inspection and maintenance of cables. If an insulating layer of the cable in a cable tunnel is damaged due to long-term operation of the cable, the cable may be prone to catching fire. Once the cable catches fire, it will seriously affect normal operation of an electric line.

The inventor found that if fire probes or sprinklers are arranged in a cable tunnel, a cost is high and a maintenance is inconvenient; most of existing cable tunnel inspection robots adopt an integrated design, and a built-in fire extinguisher, which carries a small amount of a fire-fighting medium, is arranged to extinguish fire and shows a poor fire-extinguishing effect; most of existing cable tunnel robots adopt a configuration of one robot, which cannot achieve both fire extinguishing and fire-fighting medium docking; and most of the existing cable tunnel robots are powered by batteries, and an inspection route of the cable tunnels is long, which results in a failure of timely battery charging and low inspection efficiency.

### SUMMARY

In order to solve the deficiencies of the prior art, the present disclosure provides an automatic fire-extinguishing system and method for a cable tunnel, where through the arrangement of an inspection robot and a positioning robot, both fire-fighting medium docking and fire extinguishing are realized; and through the cooperation of a first locking mechanism and a second locking mechanism, a quick access to a battery is realized and fire-extinguishing inspection efficiency of a cable tunnel is improved.

To achieve the above objective, the present disclosure adopts following technical solutions:

In a first aspect of the present disclosure, an automatic fire-extinguishing system for a cable tunnel is provided.

The automatic fire-extinguishing system for a cable tunnel includes an inspection robot, a positioning robot, and guide rails fixed on an inner top of the tunnel,
where the inspection robot is connected to the guide rails, and the positioning robot is arranged in a groove of the inspection robot and able to be moved by the inspection robot along the guide rails;

the positioning robot is connected to the guide rails and is able to independently enter and exit space of the groove of the inspection robot along the guide rails, and the positioning robot is provided with a fire source identification module and a built-in fire-extinguishing mechanism the fire; and the positioning robot is configured to identify a fire source and control a built-in fire-extinguishing mechanism to extinguish fire at a position with a preset distance from the fire source.

Further, the inspection robot may be provided with a battery slot, and the battery slot may be provided with a first locking mechanism;
the first locking mechanism may include: mounting slots located at two inner sides of the battery slot, a spring seat fixed in the mounting slot, a sliding plate slidably arranged in the mounting slot, a locking pin passing through and fixed on the sliding plate, and a spring arranged between the sliding plate and the spring seat; and
a first end of the locking pin may pass through the mounting slot, extend into the battery slot, and match with locking holes at two sides of a battery, and a second end of the locking pin may be provided with a first inclined surface.

Further, the inspection robot may include a first drive mechanism; and
the first drive mechanism may include: a first motor fixed on a top of the inspection robot, a worm fixedly connected to an output end of the first motor, a worm wheel meshed with the worm, and a first gear that is coaxially arranged with the worm wheel and meshes with a rack at a bottom of the guide rail.

Further, the positioning robot may include a second drive mechanism; and
the second drive mechanism may include: a second motor fixed on the positioning robot, and a second gear that is fixed on an output end of the second motor and meshes with the rack at the bottom of the guide rail.

Further, the fire-extinguishing mechanism may include: a winding roller arranged on the positioning robot, a telescopic pipe arranged on the winding roller, a connecting pipe connected to a first end of the telescopic pipe, a sprinkler connected to the connecting pipe, a nozzle pipe connected to the sprinkler, and a butt joint that is connected to a second end of the telescopic pipe and is configured to connect a butt pipe.

Further, the positioning robot may be provided with a third motor, and an output end of the third motor may be fixedly connected to the sprinkler; and the positioning robot may be provided with a fourth motor, and an output end of the fourth motor may be fixedly connected to the winding roller; and
the inspection robot may be provided with a butt joint mechanism that connects the butt joint and the butt pipe together, and the butt joint mechanism may include a fifth motor fixed on the inspection robot, a third gear fixed on an output end of the fifth motor, and a telescopic rod that is slidably arranged on the inspection robot, meshes with the rack, and is fixedly connected to the butt joint.

Further, the automatic fire-extinguishing system may further include storage tanks arranged at a preset interval on ground, a fire-extinguishing pipeline may be arranged between the storage tanks and the cable tunnel, and the fire-extinguishing pipeline may include a main pipeline connected to the storage tanks, a branch pipeline connected to the main pipeline, and the butt pipes evenly arranged on the branch pipeline.

Further, the automatic fire-extinguishing system may also include a loading and unloading mechanism, and the loading and unloading mechanism may include: a mounting seat fixed on a side wall of the cable tunnel, a mounting plate arranged in parallel with the mounting seat, a scissor lifting mechanism arranged between the mounting seat and the mounting plate, a pair of push rods fixed on the mounting plate, and a guide wheel rotatably arranged at a tail end of the push rod;
the push rod may be configured to approach the inspection robot under an action of the scissor lifting mechanism, and the guide wheel may be configured to pass through a side wall of the inspection robot and then enter the mounting slot to contact the first inclined surface and press against the locking pin; and
a pair of shift forks may be fixed on the mounting plate, the shift fork may match with a slot on a side wall of the battery, and a second locking mechanism for locking the battery to the shift fork may be arranged in the slot.

Further, the second locking mechanism may include: a vertical groove formed on a top of the battery, a baffle ring fixed in the vertical groove, and a bolt arranged in the vertical groove; an upper end of the bolt may be arranged above the baffle ring, and a lower end of the bolt may be arranged below the baffle ring; a round hole corresponding to the bolt may be formed at a tail end of the shift fork; and the inspection robot above the battery slot may be provided with an electromagnet matching with the bolt.

Further, two side walls of the battery which are opposite may be second inclined surfaces, a sliding slot matching with the locking pin may also be formed on the two side walls of the battery, and the sliding slot may communicate with the locking holes on the two side walls of the battery.

Further, a first wheel carrier may be fixed on the top of the inspection robot, a first traveling wheel may be rotatably arranged on the first wheel carrier, a track groove may be formed on the guide rail, and the first traveling wheel may be arranged in the track groove.

Further, a second wheel carrier may be fixed on a top of the positioning robot, a track groove may be formed on the guide rail, and a second traveling wheel in the track groove may be rotatably arranged on the second wheel carrier.

In a second aspect of the present disclosure, an automatic fire-extinguishing method for a cable tunnel is provided.

The automatic fire-extinguishing method for a cable tunnel uses the automatic fire-extinguishing system for a cable tunnel described in the first aspect of the present disclosure, including process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between the fire-extinguishing pipeline and the fire-extinguishing mechanism;
moving the positioning robot out of the inspection robot to a position at a preset distance from the fire source; and
extinguishing the fire source by the fire-extinguishing mechanism.

Compared with the prior art, the present disclosure has the following beneficial effects:
1. In the automatic fire-extinguishing system and method for a cable tunnel provided by the present disclosure, through the arrangement of an inspection robot and a positioning robot, both fire-fighting medium docking and fire extinguishing are realized; and through the cooperation of a first locking mechanism and a second locking mechanism, the quick access to a battery is realized and the fire-extinguishing inspection efficiency of a cable tunnel is improved.
2. In the automatic fire-extinguishing system and method for a cable tunnel provided by the present disclosure, once fire occurs in the cable tunnel, the inspection robot closest to the fire will move to the butt pipe closest to a fire source at the highest speed and will be connected to the butt pipe, and then the positioning robot moves out and approaches the fire source to extinguish the fire, thereby realizing rapid and automatic fire extinguishing.

Advantages of additional aspects of the present disclosure will be partially provided in the following description, and partially become evident in the following description or understood through the practice of the present disclosure.

### BRIEF DESCRIPTION OF THE DRAWINGS

The accompany drawings of the specification constituting a part of the present disclosure provide further understanding of the present disclosure. The schematic examples of the present disclosure and description thereof are provided to explain the present disclosure and do not constitute an undue limitation to the present disclosure.

FIG. 1 is a schematic structural diagram of an automatic fire-extinguishing system for a cable tunnel provided in Example 1 of the present disclosure.

FIG. 2 is a schematic diagram of assembly of an inspection robot with a track provided in Example 1 of the present disclosure.

FIG. 3 is a schematic diagram of a first traveling mechanism provided in Example 1 of the present disclosure.

FIG. 4 is a schematic diagram of a fire-extinguishing mechanism provided in Example 1 of the present disclosure.

FIG. 5 is a cross-sectional view of a fire-extinguishing sprinkler provided in Example 1 of the present disclosure.

FIG. 6 is a schematic diagram of a winding roller provided in Example 1 of the present disclosure.

FIG. 7 is a schematic diagram of assembly of a battery provided in Example 1 of the present disclosure.

FIG. 8 is a schematic diagram of a first locking mechanism provided in Example 1 of the present disclosure.

FIG. 9 is a schematic structural diagram of a locking pin provided in Example 1 of the present disclosure.

FIG. 10 is a side view of the battery provided in Example 1 of the present disclosure.

FIG. 11 is a schematic diagram of a second locking mechanism provided in Example 1 of the present disclosure.

FIG. 12 is a schematic diagram of a loading and unloading mechanism provided in Example 1 of the present disclosure.

FIG. 13 is a schematic diagram of a fire-extinguishing pipeline provided in Example 1 of the present disclosure.

FIG. 14 is a schematic diagram of a positioning robot provided in Example 1 of the present disclosure.

In the figures, 1 represents ground; 11 represents a cable tunnel; 12 represents a cable; 13 represents a fire-proof door; 2 represents a guide rail; 21 represents a track groove; 22 represents a rack; 3 represents an inspection robot; 30 represents a square slot; 31 represents a first wheel carrier; 32 represents a first traveling wheel; 33 represents a first motor; 34 represents a worm; 35 represents a worm wheel; 36 represents a first gear; 361 represents a lug; 37 represents a battery slot; 38 represents a mounting slot; 381 represents a spring seat; 382 represents a spring; 39 represents a locking pin; 391 represents a sliding plate; 392 represents a first inclined surface; 4 represents a battery; 41 represents a second inclined surface; 42 represents a sliding slot; 43 represents a locking hole; 44 represents a slot; 45 represents a vertical groove; 46 represents a baffle ring; 47 represents a bolt; 471 represents a third inclined surface; 5 represents an electromagnet; 6 represents a positioning robot; 61 represents a second wheel carrier; 62 represents a second traveling wheel; 63 represents a second motor; 64 represents a second gear; 65 represents a mounting cavity; 7 represents a sprinkler; 71 represents a nozzle pipe; 72 represents a connecting pipe; 73 represents a connector; 74 represents a third motor; 75 represents a winding roller; 76 represents a telescopic pipe; 77 represents a fourth motor; 78 represents a butt joint; 8 represents a fifth motor; 81 represents a third gear; 82 represents a telescopic rod; 83 represents a sliding rail; 84 represents a vertical rod; 9 represents a mounting seat; 91 represents a scissor lifting mechanism; 92 represents a mounting plate; 93 represents a push rod; 94 represents a guide wheel; 95 represents a shift fork; 96 represents a round hole; 10 represents a storage tank; 101 represents a main pipeline; 102 represents a branch pipeline; 103 represents a butt pipe; and 14 represents a fire-extinguishing pipeline.

### DETAILED DESCRIPTION

The present disclosure is described in further detail below with reference to the accompanying drawings and examples.

It should be noted that the following detailed descriptions are all exemplary and are intended to provide further descriptions of the present disclosure. Unless defined otherwise, all technical and scientific terms used herein have the same meanings as commonly understood by one of ordinary skill in the art to which the present disclosure belongs.

It should be noted that the terms used herein are merely used for describing specific examples, but not intended to limit the exemplary examples according to the present disclosure. As used herein, the singular form is also intended to include the plural form unless otherwise indicated clearly in the context. Further, it should be further understood that the terms “includes” and/or “including” used in this specification specify the presence of stated features, steps, operations, elements, components and/or a combination thereof.

The examples in the present disclosure and features in the examples may be combined with each other in a non-conflicting manner.

### Example 1

Example 1 of the present disclosure provides an automatic fire-extinguishing system for a cable tunnel, which includes:
guide rails fixed on a top of the cable tunnel;
an inspection robot that can move along the guide rails, where the inspection robot is provided with a first drive mechanism, such that the inspection robot can travel along the guide rails under an action of the first drive mechanism;
a battery arranged in a battery slot on the inspection robot, where the inspection robot is provided with a first locking mechanism for locking the battery;
a charging unit arranged on a side wall of the cable tunnel and configured to charge the battery;
a positioning robot arranged at an inner side of the inspection robot, where a second drive mechanism is arranged on the positioning robot such that the positioning robot can move along the guide rails under an action of the second drive mechanism, and a monitoring unit for monitoring fire is arranged on the positioning robot;
a fire-extinguishing pipeline, where storage tanks are arranged at a specified interval on ground, a fire-extinguishing pipeline is arranged between the storage tanks and the cable tunnel, and the fire-extinguishing pipeline includes a main pipeline connected to the storage tanks, a branch pipeline connected to the main pipeline, and the butt pipes evenly arranged on the branch pipeline;
a fire-extinguishing mechanism including: a winding roller arranged on the positioning robot, a telescopic pipe arranged on the winding roller, a connecting pipe connected to the telescopic pipe, a sprinkler connected to the connecting pipe, a nozzle pipe connected to the sprinkler, and a butt joint that is connected to the telescopic pipe and is configured to connect a butt pipe, where the inspection robot is provided with a butt joint mechanism that connects the butt joint and the butt pipe together; and
a loading and unloading mechanism arranged on an inner wall of the cable tunnel and configured to load and unload the battery in the battery slot.

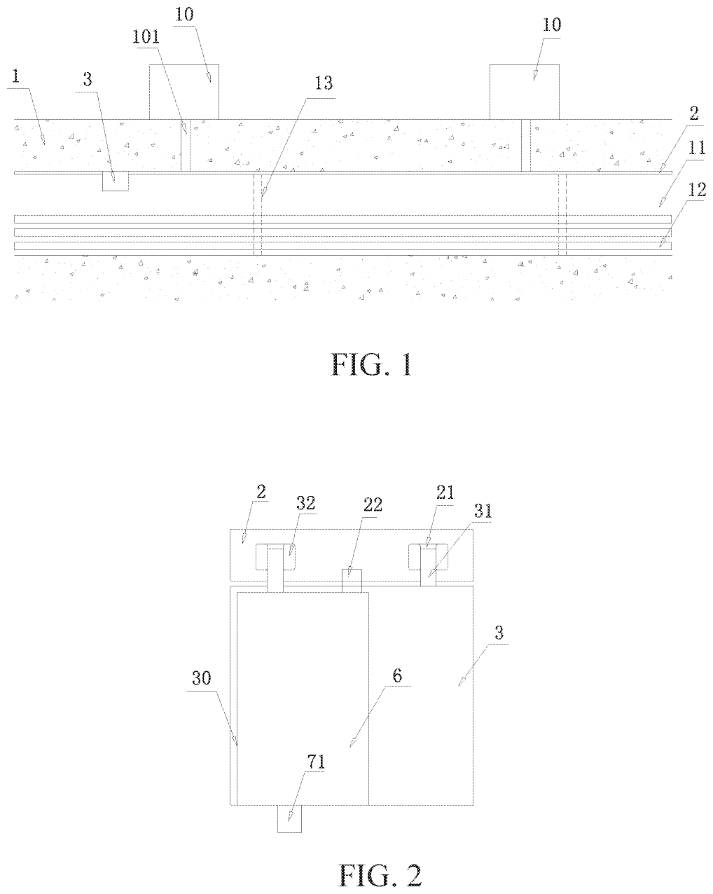

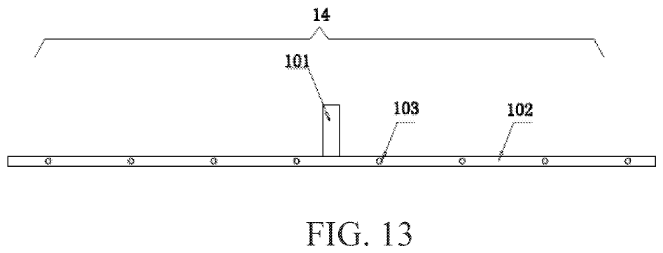

Specifically, as shown in FIG. 1 to FIG. 14, the fire-extinguishing system may include a guide rail 2, an inspection robot 3, a positioning robot 6, a fire-extinguishing pipeline 14 (it has been pointed out in FIG. 13 that the fire-extinguishing pipeline includes a main pipeline 101, a branch pipeline 102, and a butt pipe 103), and a storage tank 10. The fire-extinguishing system in this example will be described in detail below with reference to the accompanying drawings.

As shown in FIG. 1 and FIG. 2, the guide rail 2 is arranged on a top wall of the cable tunnel 11, and the cable 12 is usually arranged in middle and lower parts of the cable tunnel 11, such that the guide rail 2 is located above the cable 12; and the guide rail 2 is laid along the cable tunnel 11, two left and right track grooves 21 are formed on the guide rail 2, and a rack 22 is fixed at a bottom of the guide rail 2 between the two track grooves 21.

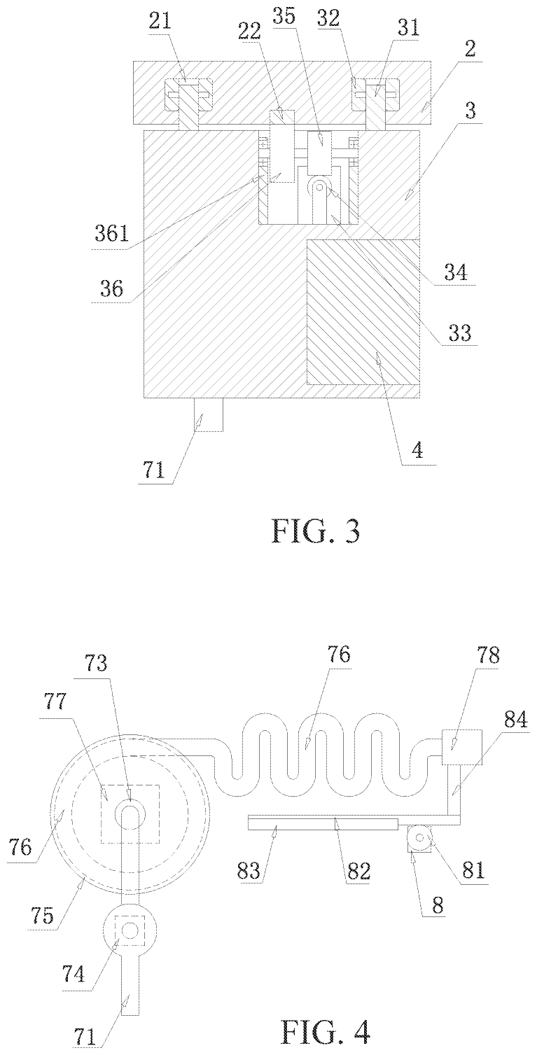

An inspection robot 3 is arranged on the guide rail 2, and the inspection robot 3 travels along the guide rail 2 to monitor the cable tunnel 11 of a specified length. For a traveling mode of the inspection robot 3 along the guide rail 2, this example is implemented as follows: as shown in FIG. 2 and FIG. 3, a first wheel carrier 31 is fixed on a top of the inspection robot 3, and there are four first wheel carriers 31 that are respectively arranged at four vertices of a rectangle; and the first wheel carrier 31 is provided with a first traveling wheel 32, and the first traveling wheel 32 extends into the track groove 21, such that the first traveling wheel 32 travels in the track groove 21, thereby realizing the movement of the inspection robot 3 along the guide rail 2.

A square slot 30 is formed on the top of the inspection robot 3, a first motor 33 is fixed in the square slot 30, a worm 34 is fixed at an output end of the first motor 33, and a worm wheel 35 is rotatably arranged in the square slot 30 through a pair of lugs 361; a first gear 36 is also fixed on a shaft of the worm wheel 35, and the first gear 36 meshes with the rack 22; and the first motor 33, the worm 34, the worm wheel 35, and the first gear 36 constitute a first traveling mechanism, and under an action of the first traveling mechanism, the inspection robot 3 is moved along the guide rail 2.

In order to provide energy for the first motor 33, a battery slot 37 is formed on a side wall of the inspection robot 3, a battery 4 is placed in the battery slot 37, and the battery 4 provides energy for the inspection robot 3; in order to charge the battery 4, a charging unit is arranged on the side wall of the cable tunnel 11, and when an electric quantity of the battery 4 is reduced, the battery 4 can be connected with the charging unit such that the battery 4 is charged; and a solar panel is arranged on ground 1, the solar panel absorbs solar energy and converts the solar energy into electric energy, and the solar panel can be connected with the charging unit to charge the battery 4. The use of solar energy to generate electricity and charge the battery 4 is already in the prior art and will not be repeated here.

When the battery 4 is arranged in the battery slot 37, it should be ensured that the battery 4 and the inspection robot 3 are relatively fixed, such as to ensure well contact between the battery 4 and the first motor 33. Therefore, a first locking mechanism is provided between the battery 4 and the inspection robot 3.

As shown in FIG. 7 and FIG. 8, the first locking mechanism includes a mounting slot 38 located in the inspection robot 3, a spring seat 381 fixed in the mounting slot 38, a sliding plate 391 slidably arranged in the mounting slot 38, a locking pin 39 fixed on the sliding plate 391, and a spring 382 arranged between the sliding plate 391 and the spring seat 381; and under an action of the spring 382, a first end of the locking pin 39 passes through the mounting slot 38 and extends into the battery slot 37.

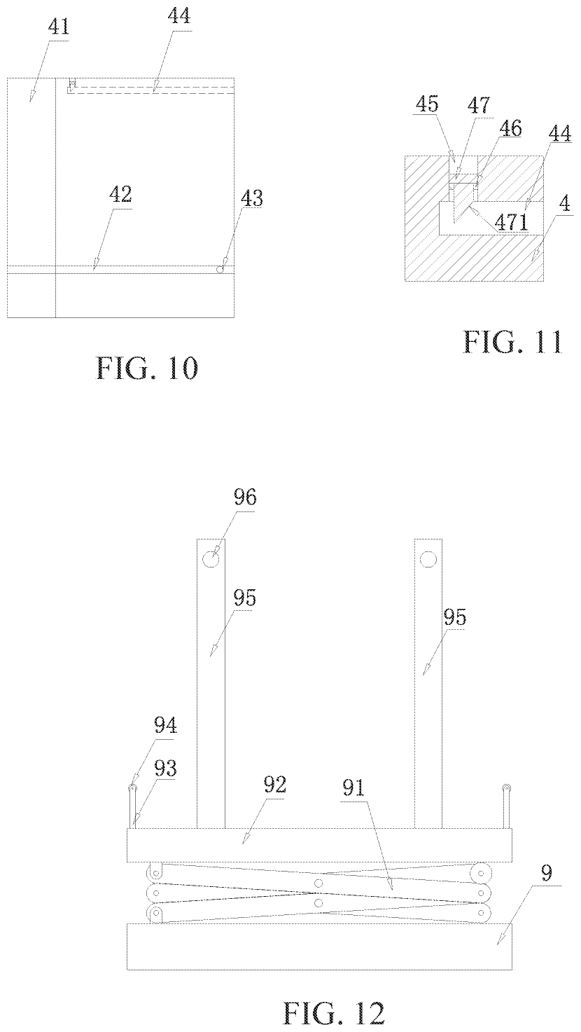

As shown in FIG. 9, a first inclined surface 392 is provided at a second end of the locking pin 39; as shown in FIG. 10, locking holes 43 are formed at lower parts of two side walls of the battery 4 which are opposite, and after the first end of the locking pin 39 extends into the locking hole 43, the battery 4 and the inspection robot 3 can be locked and fixed; and the battery 4 has a square shape as a whole, and in order to facilitate pushing the battery 4 into the battery slot 37, a pair of second inclined surfaces 41 are provided on a left end of the battery 4, such that the left end of the battery 4 is tapered.

A sliding slot 42 is also formed on the side wall of the battery 4, and the sliding slot 42 communicates with the locking hole 43. After the battery 4 is pushed into the battery slot 37, the first end of the locking pin 39 first comes into contact with the sliding slot 42 on the second inclined surface 41, and as the battery 4 is further pushed, the locking pin 39 is pressed by the second inclined surface 41. After the locking pin 39 leaves the second inclined surface 41 and the battery 4 contacts the bottom of the battery slot 37, the locking pin 39 is aligned with the locking hole 43, such that the locking pin 39 enters the locking hole 43 under an action of the spring 382 to lock and fix the battery 4.

In a natural state, the side wall of the inspection robot 3 corresponding to the first inclined surface 392 communicates with the mounting slot 38, such that the first inclined surface 392 of the locking pin 39 communicates with an outside of the inspection robot 3. In order to make the first end of the locking pin 39 move out of the locking hole 43 to facilitate the removal of the battery 4, a loading and unloading mechanism is provided on the side wall of the cable tunnel 11.

As shown in FIG. 12, the loading and unloading mechanism includes a mounting seat 9 fixed on the side wall of the cable tunnel 11, a mounting plate 92 arranged in parallel with the mounting seat 9, a scissor lifting mechanism 91 arranged between the mounting seat 9 and the mounting plate 92, a pair of push rods 93 fixed on the mounting plate 92, and a guide wheel 94 rotatably arranged at a tail end of the push rod 93.

Under an action of the scissor lifting mechanism 91, the push rod 93 approaches the inspection robot 3, the guide wheel 94 passes through the side wall of the inspection robot 3 and enters the mounting slot 38, and the guide wheel 94 contacts the first inclined surface 392 and gradually presses the locking pin 39, such that the locking pin 39 moves out of the locking hole 43, thereby realizing the release of battery locking.

In order to take out the battery 4 from the battery slot 37, a pair of shift forks 95 are fixed on the mounting plate 92, a round hole 96 is formed at a tail end of the shift fork 95, and a pair of slots 44 are formed on a side wall of an upper part of the battery 4. When the push rod 93 approaches the battery 4, the shift fork 95 extends into the slot 44, at which point the shift forks 95 and the battery should be locked and fixed together to facilitate the removal of the battery 4.

A second locking mechanism is provided on the battery 4 to lock the battery 4 with the shift fork 95. As shown in FIG. 10 and FIG. 11, a vertical groove 45 is formed on the top of the battery 4, and the vertical groove 45 communicates with the slot 44. A baffle ring 46 is fixed in the vertical groove 45, and a bolt 47 is arranged in the vertical groove 45; an upper end of the bolt 47 is larger than a lower end of the latch, the upper end of the bolt 47 is arranged above the baffle ring 46, and the lower end of the bolt 47 is arranged below the baffle ring 46; and a third inclined surface 471 is provided on the lower end of the bolt 47.

In a natural state, under an action of its own gravity, a lower end part with the third inclined surface 471 of the bolt 47 extends into the slot 44; and if the lower end of the bolt 47 extends into the round hole 96 on the shift fork 95, the locking and fixing between the battery 4 and the shift fork 95 can be achieved. During the movement of the shift fork 95 in the slot 44, the tail end of the shift fork 95 contacts the third inclined surface 471 to push up the bolt 47, and then the lower end of the bolt 47 falls into the round hole 96 with the further movement of the shift fork 95. Thus, the battery 4 can be taken out from the battery slot 37, and then placed near the side wall of the cable tunnel 11 and charged. Then, the fully-charged battery 4 is arranged in the battery slot 37, and the inspection robot 3 can continue to work. The bolt 47 and the baffle ring 46 constitute the second locking mechanism.

A process of arranging the battery 4 in the mounting slot 38 is similar to the process of removing the battery 4 out from the battery slot 37. When the shift fork 95 lifts the battery 4 into the battery slot 37, the second inclined surface 41 on the battery 4 first contacts the first end of the locking pin 39 to push the locking pin 39 out of the battery slot 37. Then the battery 4 can continue to enter the battery slot 37 until the battery 4 is in contact with the bottom of the battery slot 37, such that the battery 4 is electrically connected to the first motor 33. An interface for easy connection should be provided on the battery 4, such that after the battery 4 is arranged in the battery slot 37, the first motor 33 is stably connected to the interface on the battery 4. An electromagnet 5 is provided on the inspection robot 3 above the battery slot 37. After the electromagnet 5 is energized, the bolt 47 is lifted up by a magnetic force, such that the lower end of the bolt 47 moves out of the round hole 96 and the locking between the shift fork 95 and the battery 4 is released; and then the shift fork 95 can be removed out of the battery 4 through the scissor lifting mechanism 91, thereby realizing the arrangement of the battery 4.

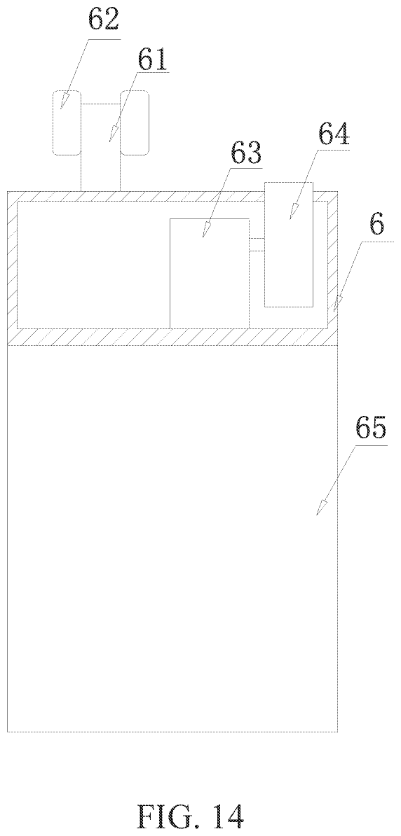

A positioning robot 6 is arranged in the inspection robot 3. As shown in FIG. 2 and FIG. 14, a pair of second wheel carriers 61 are fixed on the top of the positioning robot 6, a second traveling wheel 62 is rotatably arranged on the first wheel carrier 31, and the second traveling wheels 62 are also arranged in the track groove 21, such that the positioning robot 6 can also move relative to the guide rail 2. A second motor 63 is arranged on an upper part of the positioning robot 6, a second gear 64 is arranged at an output end of the second motor 63, and the second gear 64 meshes with the rack 22. Under an action of the second motor 63, the positioning robot 6 can move along the guide rail 2. When the inspection robot 3 travels along the guide rail 2, the second motor 63 is in a non-working state, the positioning robot 6 and the inspection robot 3 are relatively fixed, and the positioning robot 6 travels under the driving of the inspection robot 3. The second motor 63 and the second gear 64 constitute the second drive mechanism, and under an action of the second drive mechanism, the positioning robot 6 travels along the guide rail 2.

A mounting cavity 65 is formed in the lower part of the positioning robot 6, and a fire-extinguishing mechanism is arranged in the mounting cavity 65. As shown in FIG. 4, the fire-extinguishing mechanism includes a third motor 74 fixed in the mounting cavity 65, a sprinkler 7 fixed at an output end of the third motor 74, a nozzle pipe 71 fixed on and communicating with the sprinkler 7, a fourth motor 77 fixed in the mounting cavity 65, a winding roller 75 fixed at an output end of the fourth motor 77, and a telescopic pipe 76 wound on an outer wall of the winding roller 75.

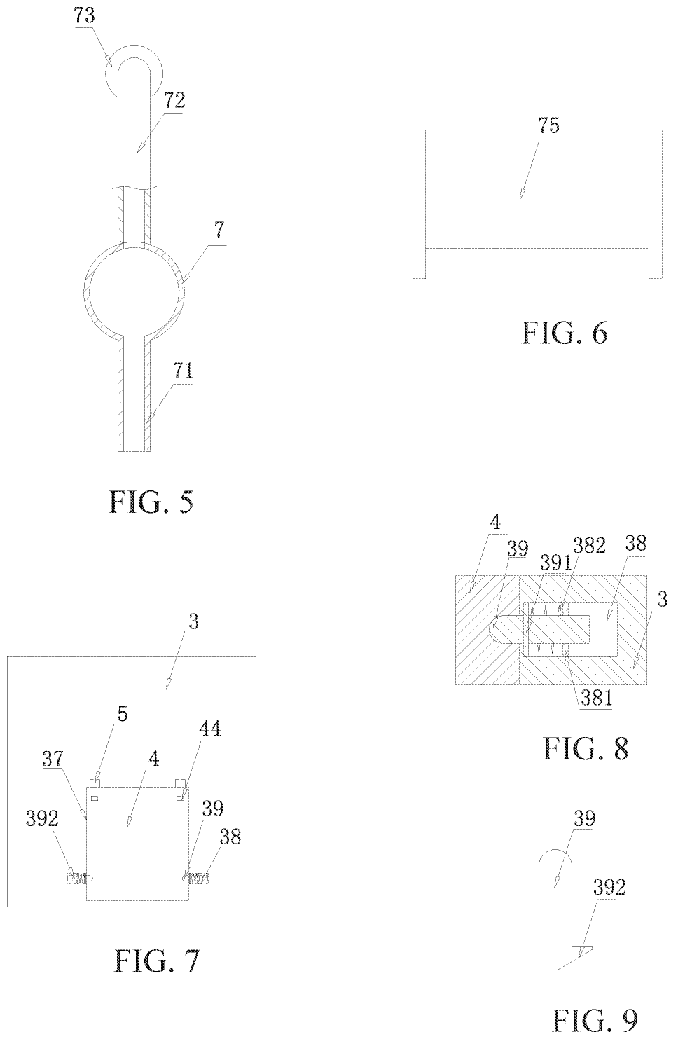

As shown in FIG. 6, two ends of the winding roller 75 are large and the middle of the winding roller is small. As shown in FIG. 5, a connecting pipe 72 is connected to the sprinkler 7, a connector 73 is provided at the tail end of the connecting pipe 72, the connecting pipe 72 and the connector 73 can rotate relative to each other, and the connector 73 and the mounting cavity 65 are relatively fixed and kept sealed. The connector 73 is fixedly connected to a first end of the telescopic pipe 76, a second end of the telescopic pipe 76 is connected to a butt joint 78, and the butt joint 78 is relatively and fixedly connected to the inspection robot 3. When fire needs to be extinguished, the butt joint 78 is connected to the fire-extinguishing pipeline on the side wall of the cable tunnel 11, such that a fire-extinguishing gas (such as carbon dioxide) or a dry powder in the fire-extinguishing pipeline can enter the telescopic pipe 76, then pass through the connecting pipe 72 and the sprinkler 7 sequentially to enter the nozzle pipe 71, and finally is sprayed out to achieve fire extinguishing.

In order to drive a connection between the butt joint 78 and the fire-extinguishing pipeline, a sliding rail 83 is arranged in the inspection robot 3, a telescopic rod 82 is slidably arranged on the sliding rail 83, and the telescopic rod 82 and the butt joint 78 are fixedly connected through a vertical rod 84; and a fifth motor 8 is arranged in the inspection robot 3, a third gear 81 is arranged at an output end of the fifth motor 8, and the third gear 81 meshes with the telescopic rod 82. When the fifth motor 8 works, the telescopic rod 82 can be driven to move toward or away from the side wall of the cable tunnel 11. A square slot 30 is formed on the side wall of the inspection robot 3, and the positioning robot 6 passes through the square slot 30 and moves out of the inspection robot 3. The fifth motor 8, the third gear 81, and the telescopic rod 82 constitute the butt joint mechanism.

A plurality of storage tanks 10 are arranged on the ground 1, and a storage tank 10 can be arranged every 1 km. The storage tank 10 is connected to the fire-extinguishing pipeline. As shown in FIG. 13, the fire-extinguishing pipeline includes a main pipeline 101 connected to the storage tank 10, a branch pipeline 102 connected to the main pipeline 101, and a butt pipe 103 connected to the branch pipeline 102. A butt pipe 103 is arranged every 10 m on the branch pipeline 102, the main pipeline 101 penetrates into the soil, and the branch pipeline 102 is arranged in the cable tunnel 11. In this way, a storage tank 10 and a fire-extinguishing pipeline are arranged at a specified interval. A fire-proof door 13 is also arranged at a specified interval in the cable tunnel 11, and the fire-proof door is in the prior art. A monitoring unit is provided on the positioning robot 6 to detect whether there is fire in the cable tunnel 11 through various sensors. A one-way valve is provided in the butt pipe 103, and a gas or solid powder can only enter the butt joint 78 through the butt pipe 103.

In the fire-extinguishing system in this example, the monitoring of fire in the cable tunnel 11 is realized through the mobile inspection robot 3. When the fire is found, the inspection robot 3 quickly moves to the nearest butt pipe 103, and the butt joint 78 and the butt pipe 103 are connected together through an action of the fifth motor 8, such that a fire-extinguishing gas or a dry powder in the storage tank 10 is fed into the branch pipeline 102 under a high pressure and then enters the telescopic pipe 76. During this process, the positioning robot 6 moves out of the inspection robot 3 to a position which is closest to the fire source, and then positions of the sprinkler 7 and the nozzle pipe 71 are adjusted through an action of the third motor 74, such that the nozzle pipe 71 directly faces the fire source. The fire-extinguishing gas or the dry powder is sprayed on the fire source through the nozzle pipe 71 to achieve fire extinguishing. After the fire extinguishing is completed, the positioning robot 6 re-monitors for a period of time to avoid re-ignition. The inspection robot 3 is also provided with a signal transmitting unit, which sends fire signal to a remote monitoring room, and then informs power personnel to deal with the scene as soon as possible. The power personnel should also check the storage tank 10 regularly to ensure that there is enough fire-extinguishing gas or dry powder in the storage tank 10 and each device works normally, such that once fire occurs in the cable tunnel 11, the inspection robot 3 closest to the fire will move to the butt pipe 103 closest to a fire source at the highest speed and will be connected to the butt pipe, and then the positioning robot 6 moves out and approaches the fire source to extinguish the fire, thereby realizing an automatic fire-extinguishing function. When the battery 4 is arranged in the battery slot 37, the battery is also electrically connected to the second to fifth motors 8.

### Example 2

Example 2 of the present disclosure provides an automatic fire-extinguishing method for a cable tunnel, including the following steps:
step 1: fire in the cable tunnel is monitored by the inspection robot arranged in the cable tunnel;
step 2: when the fire is found, the inspection robot is allowed to quickly move toward a fire source and move to a butt pipe closest to the fire source;
step 3: the fire-extinguishing mechanism is connected with the butt pipe to realize a connection between the fire-extinguishing pipeline and the fire-extinguishing mechanism;
step 4: the positioning robot is allowed to move out of the inspection robot to a position closest to the fire source; and
step 5: the fire source is extinguished by the fire-extinguishing mechanism.

The foregoing are merely preferred examples of the present disclosure and are not intended to limit the present disclosure, and various changes and modifications can be made to the present disclosure by those skilled in the art. Any modifications, equivalent substitutions, improvements, and the like made within the spirit and principle of the present disclosure should fall within the protection scope of the present disclosure.

1. An automatic fire-extinguishing system for a cable tunnel, comprising:
an inspection robot, a positioning robot, and guide rails fixed on an inner top of the tunnel,
wherein the inspection robot and the positioning robot are connected to the guide rails respectively, and the positioning robot is arranged in a groove of the inspection robot and able to be moved by the inspection robot along the guide rails; and
the positioning robot is able to independently enter and exit space of the groove of the inspection robot along the guide rails, and the positioning robot is provided with a fire source identification module and a built-in fire-extinguishing mechanism.

2. The automatic fire-extinguishing system for a cable tunnel according to claim 1, wherein the inspection robot is provided with a battery slot, and the battery slot is provided with a first locking mechanism;
the first locking mechanism comprises: mounting slots located at two inner sides of the battery slot, a spring seat fixed in the mounting slot, a sliding plate slidably arranged in the mounting slot, a locking pin passing through and fixed on the sliding plate, and a spring arranged between the sliding plate and the spring seat; and
a first end of the locking pin passes through the mounting slot, extends into the battery slot, and matches with locking holes at two sides of a battery, and a second end of the locking pin is provided with a first inclined surface.

3. The automatic fire-extinguishing system for a cable tunnel according to claim 1, wherein
the inspection robot comprises a first drive mechanism; and
the first drive mechanism comprises: a first motor fixed on a top of the inspection robot, a worm fixedly connected to an output end of the first motor, a worm wheel meshed with the worm, and a first gear that is coaxially arranged with the worm wheel and meshes with a rack at a bottom of the guide rail.

4. The automatic fire-extinguishing system for a cable tunnel according to claim 1, wherein
the positioning robot comprises a second drive mechanism; and
the second drive mechanism comprises: a second motor fixed on the positioning robot, and a second gear that is fixed on an output end of the second motor and meshes with the rack at the bottom of the guide rail.

5. The automatic fire-extinguishing system for a cable tunnel according to claim 1, wherein
the fire-extinguishing mechanism comprises: a winding roller arranged on the positioning robot, a telescopic pipe arranged on the winding roller, a connecting pipe connected to a first end of the telescopic pipe, a sprinkler connected to the connecting pipe, a nozzle pipe connected to the sprinkler, and a butt joint that is connected to a second end of the telescopic pipe and is configured to connect a butt pipe.

6. The automatic fire-extinguishing system for a cable tunnel according to claim 5, wherein
the positioning robot is provided with a third motor, and an output end of the third motor is fixedly connected to the sprinkler; and the positioning robot is provided with a fourth motor, and an output end of the fourth motor is fixedly connected to the winding roller; and
the inspection robot is provided with a butt joint mechanism that connects the butt joint and the butt pipe together, and the butt joint mechanism comprises a fifth motor fixed on the inspection robot, a third gear fixed on an output end of the fifth motor, and a telescopic rod that is slidably arranged on the inspection robot, meshes with the rack, and is fixedly connected to the butt joint;
or,
the automatic fire-extinguishing system further comprises storage tanks arranged at a preset interval on ground, a fire-extinguishing pipeline is arranged between the storage tanks and the cable tunnel, and the fire-extinguishing pipeline comprises a main pipeline connected to the storage tanks, a branch pipeline connected to the main pipeline, and the butt pipes evenly arranged on the branch pipeline.

7. The automatic fire-extinguishing system for a cable tunnel according to claim 1, wherein
the automatic fire-extinguishing system further comprises a loading and unloading mechanism, and the loading and unloading mechanism comprises: a mounting seat fixed on a side wall of the cable tunnel, a mounting plate arranged in parallel with the mounting seat, a scissor lifting mechanism arranged between the mounting seat and the mounting plate, a pair of push rods fixed on the mounting plate, and a guide wheel rotatably arranged at a tail end of the push rod;
the push rod is configured to approach the inspection robot under an action of the scissor lifting mechanism, and the guide wheel is configured to pass through a side wall of the inspection robot and then enter the mounting slot to contact the first inclined surface and press against the locking pin; and
a pair of shift forks are fixed on the mounting plate, the shift fork matches with a slot on a side wall of the battery, and a second locking mechanism for locking the battery to the shift fork is arranged in the slot.

8. The automatic fire-extinguishing system for a cable tunnel according to claim 7, wherein
the second locking mechanism comprises: a vertical groove formed on a top of the battery, a baffle ring fixed in the vertical groove, and a bolt arranged in the vertical groove; an upper end of the bolt is arranged above the baffle ring, and a lower end of the bolt is arranged below the baffle ring; a round hole corresponding to the bolt is formed at a tail end of the shift fork; and the inspection robot above the battery slot is provided with an electromagnet matching with the bolt;
or,
two side walls of the battery which are opposite are second inclined surfaces, a sliding slot matching with the locking pin is also formed on the two side walls of the battery, and the sliding slot communicates with the locking holes on the two side walls of the battery.

9. The automatic fire-extinguishing system for a cable tunnel according to claim 1, wherein
a first wheel carrier is fixed on the top of the inspection robot, a first traveling wheel is rotatably arranged on the first wheel carrier, a track groove is formed on the guide rail, and the first traveling wheel is arranged in the track groove;
or,
a second wheel carrier is fixed on a top of the positioning robot, a track groove is formed on the guide rail, and a second traveling wheel in the track groove is rotatably arranged on the second wheel carrier.

10. An automatic fire-extinguishing method for a cable tunnel using the automatic fire-extinguishing system for a cable tunnel according to claim 1, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

11. An automatic fire-extinguishing method for a cable tunnel using the automatic fire-extinguishing system for a cable tunnel according to claim 2, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

12. An automatic fire-extinguishing method for a cable tunnel using the automatic fire-extinguishing system for a cable tunnel according to claim 3, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

13. An automatic fire-extinguishing method for a cable tunnel using the automatic fire-extinguishing system for a cable tunnel according to claim 4, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

14. An automatic fire-extinguishing method for a cable tunnel using the automatic fire-extinguishing system for a cable tunnel according to claim 5, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

15. An automatic fire-extinguishing method for a cable tunnel using the automatic fire-extinguishing system for a cable tunnel according to claim 6, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between the fire-extinguishing pipeline and the fire-extinguishing mechanism;
moving the positioning robot out of the inspection robot to a position at a preset distance from the fire source; and
extinguishing the fire source by the fire-extinguishing mechanism.

16. An automatic fire-extinguishing method for a cable tunnel using the automatic fire-extinguishing system for a cable tunnel according to claim 7, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

17. An automatic fire-extinguishing method for a cable tunnel using the automatic fire-extinguishing system for a cable tunnel according to claim 8, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.

18. An automatic fire-extinguishing method for a cable tunnel using the automatic fire-extinguishing system for a cable tunnel according to claim 9, comprising process of:
monitoring fire in the cable tunnel by the inspection robot arranged in the cable tunnel;
when the fire is found, moving the inspection robot quickly toward a fire source, and to a butt pipe closest to the fire source;
connecting the fire-extinguishing mechanism with the butt pipe to realize a connection between a fire-extinguishing pipeline and the fire-extinguishing mechanism;
moving the positioning robot out of the inspection robot to a position at a preset distance from the fire source; and
extinguishing the fire source by the fire-extinguishing mechanism.
